(19) United States
(12) Patent Application Publication
(10) Pub. No.: US 2002/0175042 A1
(43) Pub. Date: Nov. 28, 2002

(54) L-shaped pallet base and pallet exchanging apparatus

(76) Inventor: Koji Nishii, Nara-ken (JP)

Correspondence Address: KUBOVCIK & KUBOVCIK, SUITE 710, 900 17TH STREET NW, WASHINGTON, DC, 20006

(21) Appl. No.: 10/146,142

(22) Filed: May 16, 2002

(30) Foreign Application Priority Data
May 18, 2001 (JP) 2001-149913

(51) Int. Cl. B65G 47/80

(52) U.S. Cl. 198/346.1

(57) ABSTRACT

In a pallet used in a conventional pallet exchanging apparatus, the side of a workpiece can be machined, but the upper surface of the workpiece cannot be machined. In this case, to machine the upper surface of the workpiece, the workpiece must be removed and great labor becomes necessary. This is solved by an L-shaped pallet base characterized in that provision is made of a first plate-like portion having female side clamps, and a second plate-like portion perpendicular to the first plate-like portion and having male side clamps. And the pallet is fixable by the female side clamps of the pallet being engaged with the male side clamps of the L-shaped pallet base, and the L-shaped pallet base becomes fixable onto a machining table by the female side clamps of the L-shaped pallet base and male side clamps disposed on the surface of the machining table being engaged with each other.

### BACKGROUND OF THE INVENTION

1. Field of the Invention

This invention relates to an L-shaped pallet base and a pallet exchanging apparatus using a conventional pallet to enable the direction of a workpiece to be easily changed without effecting the replacement of the workpiece.

2. Description of Related Art

Generally, a machining center comprises a combination of a machine tool provided with a tool, a spindle for rotating the tool, and a machining table for mounting thereon a workpiece to be machined by the tool, and an automatic tool exchanging apparatus, an automatic pallet exchanging apparatus or the like. In the machining center, the machining table or the spindle is numerically controlled so as to be moved up and down, to the left and right, and back and forth in order to machine the workpiece into a complicated shape. Combining the automatic tool exchanging apparatus, the automatic pallet exchanging apparatus or the like with the machine tool as described above is for the purpose of much shortening the time for the exchange of the tool or the replacement of the workpiece to thereby enhance the rate of the cutting time and the energy-saving effect of the machine, and shortening the time necessary for working to thereby further enhance the effect of the numerical control.

A well known art will hereinafter be described with a horizontal type machining center as an example with reference to FIGS. 7, 8A, 8B and 9 of the accompanying drawings. FIG. 7 is a general view of the horizontal type machining center as it is seen from the upper side thereof, FIG. 9 is a cross-sectional view taken along the line 9-9 of FIG. 7, and FIGS. 8A and 8B show a conventional pallet 60 generally used in the horizontal type machining center. The horizontal type machining center is provided with an automatic pallet exchanging apparatus (hereinafter referred to as the pallet exchanging apparatus) 50, a machining table 51, a column 52, a bed 53 and a spindle 54. A tool 55 for machining a workpiece which is an object to be machined is mounted on the spindle 54. The column 52 is mounted on rails disposed on the bed 53 of the machining center. The rails extend along a direction perpendicular to the axial direction of the tool. The column 52 is a device provided with rails extending vertically upwardly from on the first-mentioned rails. Also, the spindle 54 is mounted on the rails of the column 52. Accordingly, the column 52 is movable on the bed 53 in a horizontal direction perpendicular to the axial direction of the tool 55, and the spindle 54 is movable in a vertical direction along the column 52. On the other hand, the machining table 51 is movable relative to the bed 53 in a horizontal direction parallel to the axial direction of the tool. That is, the tool 55 is moved two-dimensionally in a plane perpendicular to the axial direction of the tool 55 by the movement of the column 52 and the spindle 54 and together therewith the three-dimensional machining of the workpiece which is the object to be machined becomes possible by the movement of the machining table 51.

Workpieces are fixed onto a pallet 60 to a pallet 65 which will be described later. The workpiece fixed onto the pallet 65 fixed onto the machining table 51 is machined by the tool 55. The pallet exchanging apparatus 50 is disposed on the opposite side of the tool 55 with the machining table 51 as the center, and exchanges the pallet 65 with another pallet. A workpiece is also fixed onto the exchanged pallet and machining is sequentially progressed while a workpiece after machined and a workpiece before machined are exchanged with each other.

The pallet exchanging apparatus 50 is provided with a disc table 56 and a workpiece exchange stand 57. The disc table 56 has a rotary central shaft 56a rotated to effect the conveyance of the pallet. The disc table 56 is disposed so that the rotary central shaft 56a thereof may be located on the extension of the center of rotation of the spindle 54. The workpiece exchange stand 57 is disposed in a direction perpendicular to a line passing through the central shaft 56a of the disc table 56 and the center of rotation of the machining table 51. A workpiece is fixed to the pallet 64 on the workpiece exchange stand 57 and is placed onto the disc table 56, and is conveyed to the machining table 51 by the disc table 56. The pallet exchanging apparatus 50 is further provided with a first pallet delivery (transfer) device 58 for exchanging a pallet having a workpiece fixed thereto between the workpiece exchange stand 57 and the disc table 56, and a second pallet delivery device 59 for exchanging a pallet having a workpiece fixed thereto between the machining table 51 and the disc table 56. The first pallet delivery device 58 and the second pallet delivery device 59 are rotated about the center 58a and the center 59a, respectively, to thereby effect the exchange of the pallets.

In order to describe the pallet exchanging apparatus 50, the pallet 60 will first be described with reference to FIGS. 8A and 8B. FIG. 8A shows the upper surface 60a of the pallet 60, and FIG. 8B shows the lower surface 60b of the pallet 60. The pallet 60 is a pallet made common, and the pallet 60 to the pallet 65 in FIG. 7 are of entirely the same shape and structure as the pallet 60.

The pallet 60 has a substantially square configuration with two parallel sides each as the sides thereof. The pallet 60 is formed with through-holes 9, which are arranged at constant intervals so as to be parallel to the above-mentioned two parallel sides each. These through-holes 9 are used to fix the workpiece to the pallet by bolts or the like.

On the other hand, two female side guide clamps 81 and two female side datum clamps 82, thus four in total, are disposed on the back of the pallet 60. The details of the female side guide clamps 81 and the female side datum clamps 82 will be described later. The female side guide clamps 81 and the female side datum clamps 82 are disposed at the respective corners of a square with the interval (the interval D in FIG. 8B) between their centers as a side. The median lines of lines linking the centers of the female side guide clamps 81 and the female side datum clamps 82 together are disposed so as to coincide with the median lines of the respective sides forming the configuration of the pallet. The female side guide clamps 81 are disposed at the two corners on a diagonal line, and the female side datum clamps 82 are disposed at the two corners on the other diagonal line.

A handle 66 is attached to a side of the pallet 60. Handles 67 to 71 are also attached to the pallets 61 to 65, respectively. The handle 66 has an aperture 72a and an aperture 72b formed in a side thereof adjacent to the lower surface 60b of the pallet.

The disc table 56 will now be described with reference to FIG. 9. The disc table 56 is rotatable about a central shaft 56a which is in a vertical direction. Male side clamps 80 are disposed on the upper surface of the disc table 56 on the circumference thereof centering around the central shaft 56a. These male side clamps 80 will be described later with the female side guide clamps 81 and the female side datum clamps 82. The male side clamps 80 can be disposed vertically upwardly on the disc table 56 such that the center angles of the adjacent male side clamps 80 are common on the disc table 56. In that case, the straight interval between the adjacent male side clamps 80 is adapted to be substantially the same as the straight interval D formed between the female side guide clamp 81 and the female side datum clamp 82 disposed on the lower surface of the pallet 60.

The workpiece exchange stand 57 is provided with four male side clamps 80 on the upper surface thereof to place the pallet 60 thereon. The interval between adjacent ones of the male side clamps 80 is D and the male side clamps 80 are adapted to fit into the female side guide clamps 81 and the female side datum clamps 82 disposed on the lower surface of the pallet 60 to thereby fix the pallet 60.

Between the workpiece exchange stand 57 and the disc table 56, there is disposed the first pallet delivery device 58 for effecting the conveyance of the pallet between the workpiece exchange stand 57 and the disc table 56.

The first pallet delivery device 58 will now be described with reference to FIGS. 7 and 9. The first pallet delivery device 58 is provided with a rotary stand 58b rotated about a vertical central shaft 58a, and an arm 58c and an arm 58d protruding vertically upwardly from the upper surface of the rotary stand 58b. The arm 58c and the arm 58d are arms each comprising a pair of arms and are disposed rotation-symmetrically with respect to an axis of the central shaft 58a and line-symmetrically with respect to a line linking the central shaft 58a, and the central shaft 56a of the disc table 56 together. These arms 58c and 58d fit in the apertures 70a and 70b (corresponding to the apertures 72 and 72b of the pallet 60), of the handle 66 of the pallet 60 and can support the pallet 60. When the position at which the diagonal lines of the four male side clamps 80 disposed on the workpiece exchange stand 57 intersect with each other is defined as the center of the workpiece exchange stand 57, the arm 58c and the arm 58d and the central shaft 58a of the first pallet delivery device 58 are disposed so as to form a row on a line linking the central shaft 56a of the disc table 56 and the center of the workpiece exchange stand 57 together. The distances between the male side clamps 80 on the workpiece exchange stand 57 and the arms 58c and 58d and the central shaft 58a of the first pallet delivery device 58 are substantially equal to the distances between the male side clamps 80 on the disc table 56 and the arms 58c and 58d and the central shaft 58a of the first pallet delivery device 58. That is, for example, in a state in which the pallet 63 is placed on the disc table 56 and the pallet 64 is placed on the workpiece exchange stand 57, the pallet 63 and the pallet 64 are in a rotation-symmetrical positional relation centering around the central shaft 58a of the first pallet delivery device 58.

The machining table 51, like the workpiece exchange stand 57, is provided with four male side clamps 80 on the upper surface thereof to place the pallets 60 to 65 thereon. The interval between adjacent ones of the male side clamps 80 is D and the male side clamps 80 are adapted to fit into the female side guide clamps 81 and the female side datum clamps 82 disposed on the lower side of the pallet 60 and thereby be capable of fixing the pallets 60 to 65. Between the machining table 51 and the disc table 56, there is disposed the second pallet delivery device 59 for effecting the delivery of the pallets between the machining table 51 and the disc table 56.

The second pallet delivery device 59 will now be described. The second pallet delivery device 59 is substantially similar in structure to the first pallet delivery device 58. The second pallet delivery device 59 is provided with a rotary stand 59b rotated about the central shaft 59a thereof, and an arm 59c and an arm 59d protruding vertically upwardly from the upper surface of the rotary stand 59b. The arm 59c and the arm 59d as in the first pallet delivery device 58 shown in FIG. 9, if the pallet 60 is taken as an example, fit in the apertures 72a and 72b, of the handle 66 of the pallet 60 and can support the pallet 60. When the position at which the diagonal lines of the four male side clamps 80 disposed on the machining table 51 intersect with each other is defined as the center of the machining table 51, the arms 59c and 59d and the central shaft 59a of the second pallet delivery device 59 are disposed so as to form a row on a line linking the central shaft 56a of the disc table 56 and the center of the machining table 51 together. Also, when as shown in FIG. 9. the pallet 62 and the pallet 65 are to be exchanged with each other, the positions of the arm 59c, the arm 59d, the male side clamps 80 on the machining table 51 and the male side clamps 80 on the disc table 56 are set so that the distances from the central shaft 59a of the second pallet delivery device 59 to the arm 59c and 59d may be substantially equal to each other and the distances from the central shaft 59a to the male side clamps 80 on the machining table 51 and the male side clamps 80 on the disc table 56 may be substantially equal to one another. That is, in the state of FIG. 9 in which the pallet 62 is placed on the disc table 56 and the pallet 65 is placed on the machining table 51, the pallet 62 and the pallet 65 are in a rotation-symmetrical positional relation centering around the central shaft 59a of the second pallet delivery device 59.

When the pallet 60, the pallet 61, the pallet 62 and the pallet 63 are to be mounted on the disc table 56, and when the pallet 65 is to be mounted on the machining table 51, and when the pallet 64 is to be mounted on the workpiece exchange stand 57, the fitting of the male side clamps 80 disposed on the disc table 56, the machining table 51 and the workpiece exchange stand 57 and the female side guide clamps 81 and the female side datum clamps 82 disposed on the lower surfaces of the pallet 60 to the pallet 65 is utilized as previously described. The male side clamps 80, the female side guide clamps 81 and the female side datum clamps 82 will be described here with reference to FIG. 10 of the accompanying drawings.

FIG. 10 shows a state in which the female side datum clamp 82 is coupled and fixed to the male side clamp 80 (so-called locked state). The male side clamp 80 is mounted on the machining table, while on the other hand the female side datum clamp 82 is mounted on the pallet 60 side.

The male side clamp 80 is provided with a rod 80a which is a projection, a main body 80b, a ball 80c, a tapered sleeve 80d, a base 80e, a chamber 80g, a trap port 80h, and a hydraulic port 80i. This male side clamp 80 is fixed onto the machining table 51. The main body 80b is disposed on the base 80e, and they are combined together and fixed to each other. The rod 80a is disposed in the interior of the male side clamp 80, and the rod 80a is slidable in the direction of the center axis thereof (the vertical direction as viewed in FIG. 10) in the main body 80b. The rod 80a is biased toward the machining table 51 (downwardly as viewed in FIG. 10) by a spring 80j. Accordingly, usually the rod 80a is in a state in which it does not protrude from the main body. A depression 80k is provided near the upper portion of the rod 80a, and the ball 80c is mounted in a main body portion at a location corresponding to this depression. The chamber 80g is disposed in the interior of the base 80e and the lower portion of the rod 80a. This chamber 80g is connected to the hydraulic port 80i. The trap port 80h is a vent hole for smoothly sliding the rod 80a.

On the other hand, the female side datum clamp 82 will be described. The female side datum clamp 82 is an annular block formed with a taper 82a therein, and is mounted in an aperture formed in the lower surface 60b of the pallet 60.

Description will now be made of how the male side clamp 80 and the female side datum clamp 82 are engaged with and fixed to each other or separated from each other. When oil is introduced into the chamber 80g through the hydraulic port 80i and pressurized, the rod 80a rises against the spring 80j by the oil pressure. Thereupon, the ball 80c which is a movable member moves radially inwardly so as to go into the depression 80k. Thereby, the engagement of a stopper 82b in the interior of the female side datum clamp 82 is released, and the female side datum clamp 82 and the male side clamp 80 become disengageable from each other and the male side clamp 80 is liberated.

Conversely, in this state, the male side clamp 80 is inserted into the female side datum clamp 82 and the ball 80c has come to the inside of the stopper of the female side datum clamp 82, whereupon the tapered sleeve 80d of the male side clamp 80 abuts against the tapered portion 82a of the female side datum clamp 82 and is disposed at an accurate position. Thereafter, when the oil pressure of the trap port 80h is made into the atmospheric pressure, the rod 80a is lowered to the machining table 51 side by the spring 80j, and the ball 80c moves radially outwardly from the main body portion 80b. As a result, the ball 80c comes into engagement with the stopper 82b and is fixed.

The female side guide clamp 81 is almost similar in structure to the female side datum clamp 82, but preferably differs from the latter in that a guide sleeve (not shown) is disposed instead of the tapered sleeve 80d. The guide sleeve does not abut against the female side guide clamp 81, but keeps a constant gap with respect to the latter. That is, design is made such that the female guide clamp 81 creates the surplus in the surface directions of the machining table 51 and the pallet 60 in order to be precisely positioned, and the female side datum clamp 82 firmly fixes the male side clamp 80 by abutting against the tapered sleeve 80d of the male side clamp 80 in the tapered portion 82a of the female side datum clamp 82. Accordingly, the female datum clamp 82 and the female guide clamp 81 are disposed on different diagonal lines.

How the pallet exchanging apparatus 50 operates in the above-described construction will now be described with reference to FIGS. 7 and 9. A workpiece (not shown) to be machined is fixed onto the pallet 64 on the workpiece exchange stand 57 of the pallet exchanging apparatus 50. When the fixing of the workpiece is terminated, the rotary stand 58b of the first pallet delivery device 58 is elevated. Thereupon, the arm 58c fits into the apertures 74a and 74b of the handle 69 of the pallet 63, and the arm 58d fits into the aperture 75a and the aperture 75b of the handle 70 of the pallet 64, and the arm 58c and the arm 58d raise the pallet 63 and the pallet 64, respectively. Thereafter, when the rotary stand 58b is rotated, the positions of the pallet 63 and the pallet 64 change places with each other. After they have changed places with each other, the rotary stand 58b is lowered and places the pallet 63 and the pallet 64 on the workpiece exchange stand 57 and the disc table 56, respectively. At that time, the male side clamps 80 on the workpiece exchange stand 57 come into engagement with the female side guided clamps 81 and the female side datum clamps 82 of the pallet 63 and are fixed, and the male side clamps 80 on the disc table 56 come into engagement with the female side guide clamps 81 and the female side datum clamps 82 of the pallet 64 and are fixed. The work of a workpiece being newly fixed to the pallet 63 having changed places with the pallet 64 is done, while on the other hand, the disc table 56 is rotated and conveys the pallet 64 to the location of the second pallet delivery device 59.

When the pallet 64 is conveyed to the location of the second pallet delivery device 59, the pallet 64 assumes the position of the pallet 62 in FIG. 7 (in this paragraph, the pallet 64 will hereinafter be described as the pallet 62). Here, the rotary stand 59b of the second pallet delivery device 59 is elevated. Thereupon, the arm 59c fits into the apertures 73a and 73b of the handle 68 of the pallet 62, and the arm 59d fits into the apertures 76a and 76b of the handle 71 of the pallet 65, thereby raising the pallet 62 and the pallet 65. Thereafter, when the rotary stand 59b is rotated, the pallet 62 and the pallet 65 are rotated and their positions change places with each other. The rotaty stand 59b is lowered and places the pallet 62 and the pallet 65 onto the machining table 51 and the disc table 56, respectively. The male side clamps 80 on the machining table 51 and on the disc table 56 then come into engagement with the female side guide clamps 81 and the female side datum clamps 82 of the pallet 62 and the pallet 65 and are fixed thereby.

By these series of operations being repeated, the workpieces can be exchanged between the workpiece exchange stand 57 and the machining table 51.

In this state, the column 52 is moved relative to the bed 53 in a direction perpendicular to the axial direction of the tool 55, and the spindle 54 is moved in a vertical direction by the column 52, and the machining table 51 moves the workpiece with the pallet 65 back and forth in a direction along the central shaft of the tool 55, whereby three-dimensional machining can be done.

As described above, the machining center is an apparatus having as its object to much shorten the time for the exchange of the tools and the replacement of the workpieces to thereby enhance the rate of the cutting time and the energy-saving effect of the machine, and shorten the time necessary for machining to thereby further enhance the effect of numerical control. The conventional apparatus described above, however, has suffered from the following problems.

(1) For example, in the horizontal type machining center described as the conventional apparatus, the tool 55 is mounted so as to extend in a horizontal direction and the machining table 51 is horizontally disposed. The workpiece to be machined is fixed onto the machining table 51. The tool 55 is moved in a direction perpendicular to the central shaft thereof while being rotated about the lengthwise central shaft of the tool 55, and the machining table is moved along the axial direction of the tool whereby a surface of the workpiece opposed to the tool can be machined. Also, the machining table 51 is rotatable about a direction perpendicular to the plane of the machining table and therefore, by this rotation, the workpiece is rorated, whereby the workpiece can be disposed so that the other surface thereof may be opposed to the tool. By repeating this, the machining of all of the sides of the workpiece becomes possible. However as regards the upper surface of the workpiece, i.e., the upper surface parallel to the machining table 51, the tool 55 cannot be opposed to the upper surface even by the rotation of the machining table 51 and therefore, only the machining of four surfaces could be done. Accordingly, when the machining of the upper surface of the workpiece is necessary, it is unavoidable to remove the workpiece itself and again fix the workpiece so that the upper surface thereof may be opposed to the tool, and machine the workpiece. Therefore, the step of changing the direction of the workpiece becomes discretely necessary, and this is great labor. This is against the purpose of the machining center which much shortens the time required for the exchange of the tools and the replacement of the workpieces to thereby enhance the rate of the cutting time and the energy-saving effect of the machine, and shortens the time necessary for machining to thereby further enhance the effect of numerical control, as described above, and cannot sufficiently bring out the effect of the machining center and is disadvantageous. Particularly, when the number of workpieces is great, there arise great problems such as the increase in the working time and the increase in the number of the machining steps due to the above-described labor, and means for easily changing the direction of the workpiece becomes necessary.

(2) In order to solve the problem described in item (1) above, a method of three-dimensionally moving a spindle stock by numerical control to thereby enable the tool to be disposed on the upper surface of a workpiece, for example, a 5-axis control working machine would occur to mind. In such an apparatus, however, it becomes necessary to provide on the machine tool side a special driving apparatus for accurately moving the spindle stock relative to the workpiece, and further effect data processing for numerically controlling this. As a result, in the apparatus having taken such a measure, an increase in cost is inevitable. The machining center has as its object to combine an automatic tool exchanging apparatus, an automatic pallet exchanging apparatus or the like with a machine tool to thereby much shorten the time for the exchange of tools and the replacement of workpieces to thereby enhance the rate of the cutting time and the energy-saving effect of the machine, and shorten the time necessary for machining to thereby further enhance the effect of numerical control and therefore, to take the above-described measure in the machine tool itself cannot be said to utilize the given effect of numerical control of the machine tool at its maximums. Accordingly, it becomes necessary to solve the above-noted problem by an automatic pallet exchanging apparatus.

(3) Generally the machining process comprises a plurality of machining process, and the number of workpieces is generally great. Also, it is usual to machine these many workpieces by a machining center, and in that case, it is efficient to machine the workpieces in each machining process while replacing one workpiece with another. Accordingly, it becomes necessary that it is made possible to easily change the direction of the workpiece and moreover, that no problem will arise even if there are mixedly present workpieces differing in direction from one another. These and other objects and advantages of the invention may be readily ascertained by referring to the following description and accompanying drawings.

### SUMMARY OF THE INVENTION

It is an object of the present invention to solve the above-noted problems and to provide an L-shaped pallet base in which when an object to be machined (hereinafter referred to as the workpiece) from a plurality of directions is to be machined by a machining center capable of machining from only one direction, a conventional pallet can be intactly used and the pallet can be conveyed without distinction and it is made possible to effect the exchange of directions.

It is another object of the present invention to provide an L-shaped pallet base for use in a machining center in which first engaging means is disposed on the surface of a machining table, and for fixing a pallet provided with a surface having second engaging means engageable with the first engaging means and a surface for fixing a workpiece, the L-shaped pallet base being provided with a first plate-like portion including a first surface having second engaging means, and a second plate-like portion including a second surface perpendicular to the first surface and having first engaging means, wherein the second engaging means of the pallet and the first engaging means of the L-shaped pallet base are engaged with each other, whereby the pallet is fixable to the second surface, and the second engaging means of the L-shaped pallet base and the first engaging means disposed on the surface of the machining table are engaged with each other, whereby the L-shaped pallet base becomes fixable onto the machining table. That is when the machining of a side of the workpiece is to be effected, the machining of the side of the workpiece is effected as it has heretofore been done by the utilization of a pallet on which the workpiece can be horizontally placed. When the upper surface of the workpiece is to be machined, the pallet is placed on the L-shaped pallet base, the second engaging means of the pallet and the first engaging means of the L-shaped pallet base are engaged with each other whereby the pallet is fixed to the second surface, and in this state, the L-shaped pallet base is rotated and the second engaging means of the L-shaped pallet base and the first engaging means disposed on the surface of the machining table are engaged with each other, whereby the L-shaped pallet base is fixed onto the machining table. In this state, the pallet is standing in a vertical direction and therefore, the machining of the upper surface of the workpiece becomes possible. By this apparatus, it is possible to change the location of the workpiece simply at a low cost and effect the machining of the five surfaces of the workpiece including the upper surface.

### BRIEF DESCRIPTION OF THE DRAWINGS

FIG. 1 is a general view of the pallet exchanging apparatus of the present invention as it is seen from above it.

FIG. 2 is a cross-sectional view of the pallet exchanging apparatus of FIG. 1.

FIG. 3A shows the upper surface of a pallet applied to the present invention.

FIG. 3B shows the lower surface of the pallet applied to the present inventions.

FIG. 4A is a front view of an L-shaped pallet base applied to the present invention.

FIG. 4B shows the lower surface of the L-shaped pallet base applied to the present invention.

FIG. 4C shows a side of the L-shaped pallet base applied to the present invention.

FIG. 4D shows another side of the L-shaped pallet base applied to the present invention.

FIG. 5 is a side view of a turning apparatus for the L-shaped pallet base of the present invention.

FIG. 6 shows the turning apparatus for the L-shaped pallet base shown in FIG. 5 as it is seen in the direction of arrow Y.

FIG. 7 is a general view of a conventional pallet exchanging apparatus as it is seen from above it.

FIG. 8A shows the upper surface of a conventional pallet.

FIG. 8B shows the lower surface of the conventional pallet.

FIG. 9 is a cross-sectional view of the conventional pallet exchanging apparatus.

FIG. 10 is a cross-sectional view showing a female side datum clamp and a male side clamp as they are coupled together, and showing a half part divided by the center line.

### DESCRIPTION OF THE PREFERRED EMBODIMENTS

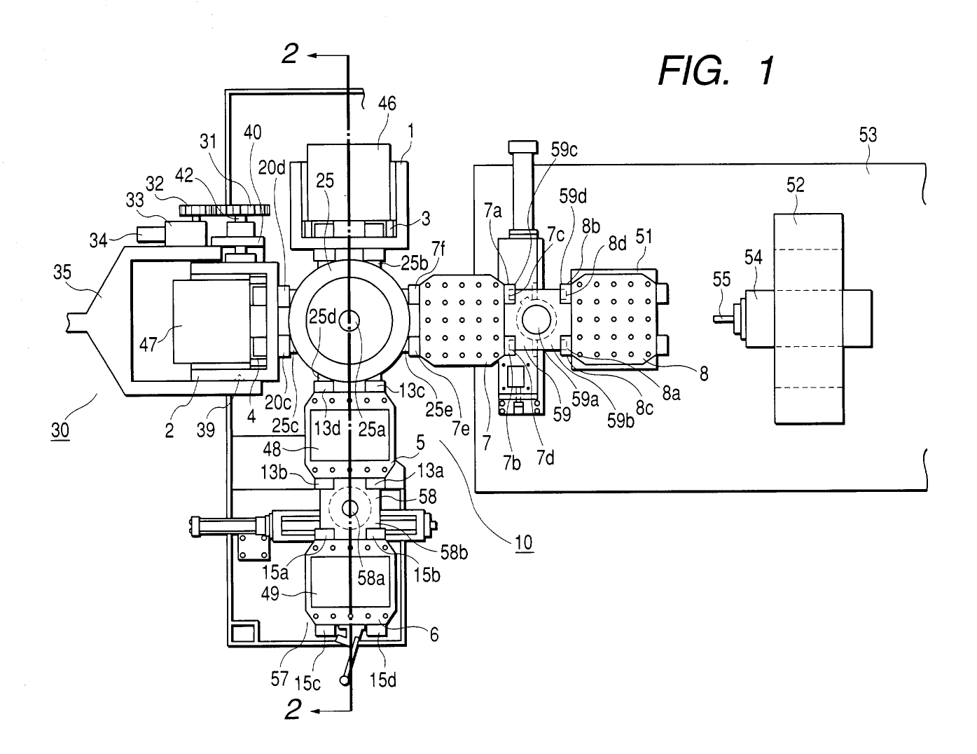

An embodiment of the present invention will hereinafter be described with reference to FIGS. 1 to 4D.

FIG. 1 is a view of an L-shaped pallet base to which the present invention is applied, a pallet and a pallet exchanging apparatus for exchanging them as they are seen from the upper side of the apparatus. As shown in FIG. 1, the pallet exchanging apparatus 10 is disposed adjacent to a spindle stock 54 and a machining table 51 disposed on the bed 53 of a machining center.

Reference is first had to FIG. 1 to describe the pallet exchanging apparatus of the machining center to which the present invention is applied. The machining center to which the present invention is applied, like the conventional machining center, is provided with the pallet exchanging apparatus 10, the machining table 51, a column 52, the bed 53 and a spindle 54. A tool 55 for working a workpiece which is an object to be machined is mounted on the spindle 54. The column 52 is mounted on rails disposed on the bed 53 of the machining center. These rails extend along a direction perpendicular to the axial direction of the tool 55. The column 52 is a device provided with rails extending vertically upwardly from the first-mentioned rails. Also, the spindle 54 is mounted on the rails of the column 52. Accordingly, the column 52 is movable on the bed 53 in a horizontal direction parallel to the axial direction of the tool 55, and the spindle 54 is movable in a vertical direction along the column 52. On the other hand, the machining table 51 is movable relative to the bed 53 in a horizontal direction parallel to the axial direction of the tool. That is, the tool 55 can two-dimensionally machine in a plane perpendicular to the axial direction thereof by the movement of the column 52 and the spindle 54, and together with this, becomes capable of effecting the three-dimensional machining of the workpiece which is the object to be machined by the movement of the machining table 51. The column 52 and the machining table 51 are moved and effect the machining of the workpiece and therefore, herein, the constant positions of the column 52 and the machining table 51 during pallet exchange are called the origin positions.

The pallet exchanging apparatus 10 is provided with a disc table 25, a workpiece exchange stand 57, a turning device 30, a first pallet delivery device 58, and a second pallet delivery device 59. The disc table 25 has a rotary central shaft 25a rotated and extending in a vertical direction for effecting the conveyance of the pallet.

The disc table 25 is disposed so that the rotary central shaft 25a thereof may be located on the extension of the center axis of the tool 55 at the origin position of the column 52. Further, the center of the machining table 51 at the origin position is located on this extension. The second pallet delivery device 59 for exchanging the pallet to which the workpiece is fixed is provided between the machining table 51 and the disc table 25. The second pallet delivery device 59 is rotated about the center 59a thereof which is the central shaft in a vertical direction to thereby effect the exchange of the pallet.

The workpiece exchange stand 57 is disposed on an extension passing through the central shaft 25a of the disc table 25 and perpendicular to the extension of the center axis of the tool 55 at the origin position of the column 52. The first pallet delivery device 58 for exchanging the pallet to which the workpiece is fixed is provided between the workpiece exchange stand 57 and the disc table 25. The first pallet delivery device 58 is rotated about the center 58a thereof which is the central shaft in a vertical direction to thereby effect the exchange of the pallet.

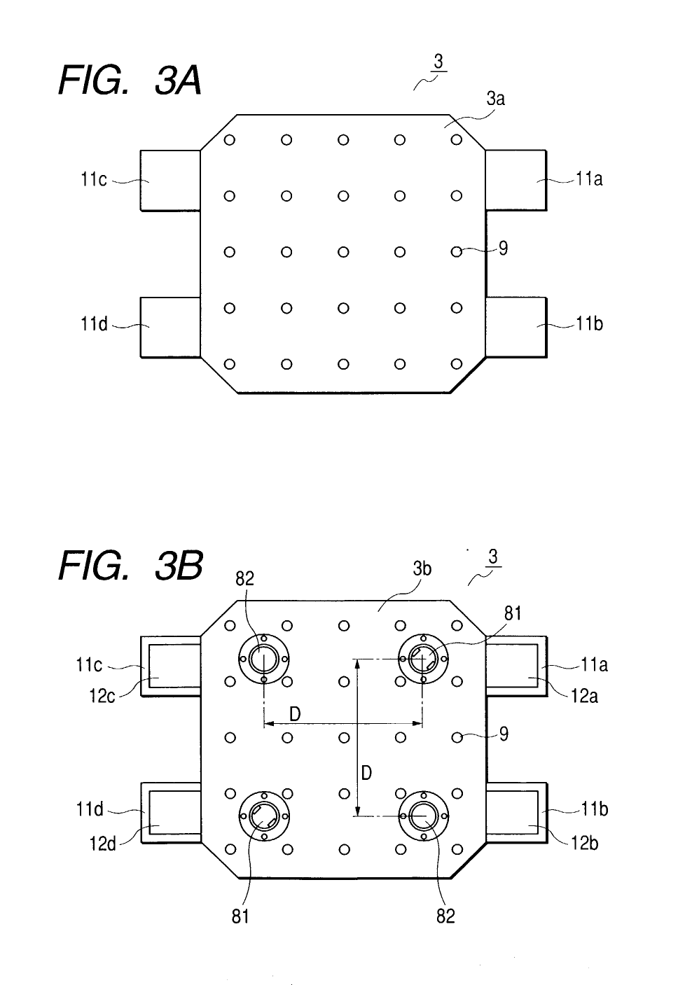

The pallet 3 of the present invention used in the pallet exchanging apparatus 10 will be described here with reference to FIGS. 3A and 3B. FIGS. 3A and 3B show the pallet 3. FIG. 3A shows the upper surface 3a of the pallet 3, and FIG. 3B shows the lower surface 3b of the pallet 3. The pallet 3 used in the pallet exchanging apparatus 10 is a pallet having a shape and structure made common and accordingly, the pallet 3, a pallet 4, a pallet 5, a pallet 6, a pallet 7 and a pallet 8 also have the same shape and structure.

The pallet 3 has a substantially square configuration having two parallel sides each as sides. In this point, the pallet 3 is the same as the conventional pallet. The pallet 3 is formed with through-holes 9, which are disposed at constant intervals so as to be parallel to the two parallel sides constituting the configuration. These through-holes 9 are used to fix a workpiece 46, a workpiece 47, a workpiece 48 or a workpiece 49 to the pallet 3 by bolts or the like.

On the other hand, female side clamps which are second engaging means are disposed on the lower surface 3b of the pallet 3. These female side clamps comprise two kinds of clamps, i.e. two female side guide clamps 81 and two female side datum clamps 82, thus four in total. The details of the female side guide clamps 81 and the female side datum clamps 82 are as described in the conventional apparatus. The female side guide clamps 81 and the female side datum clamps 82 are disposed at the respective corners of a square in which the centers thereof have a constant interval therebetween (an interval D in FIG. 3B) as a side. The median lines of lines linking the centers of adjacent ones of the female side guide clamps 81 and the female side datum clamps 82 together are disposed so as to coincide with the median lines of the respective sides forming the configuration of the pallet. The female side guide clamps 81 are disposed at the two corners on a diagonal line, while the female side datum clamps 82 are disposed at the two corners on the other diagonal line.

Also, the pallet 3 of the present invention, unlike the conventional pallet 60, has two handles 11a and 11b attached to a side thereof, and further has handles 11c and 11d attached to a side opposite to that side. The handles 11a and 11b are disposed so as to be line-symmetrical with respect to the median line of the edge of the side to which they are attached, and the handles 11c and 11d are also disposed so as to be line-symmetrical with respect to the median line of the edge of the configuration of the side to which they are attached. The handles 11a, 11b and the handle 11c, 1id have apertures 12a, 12b and apertures 12c, 12d formed in the sides thereof adjacent to the lower surface 3b of the pallet 3. These apertures give birth to the effect that the holding by the disc table 25 which will be described later is effected only by an arm, whereby the pallet 3 can be held in both direction.

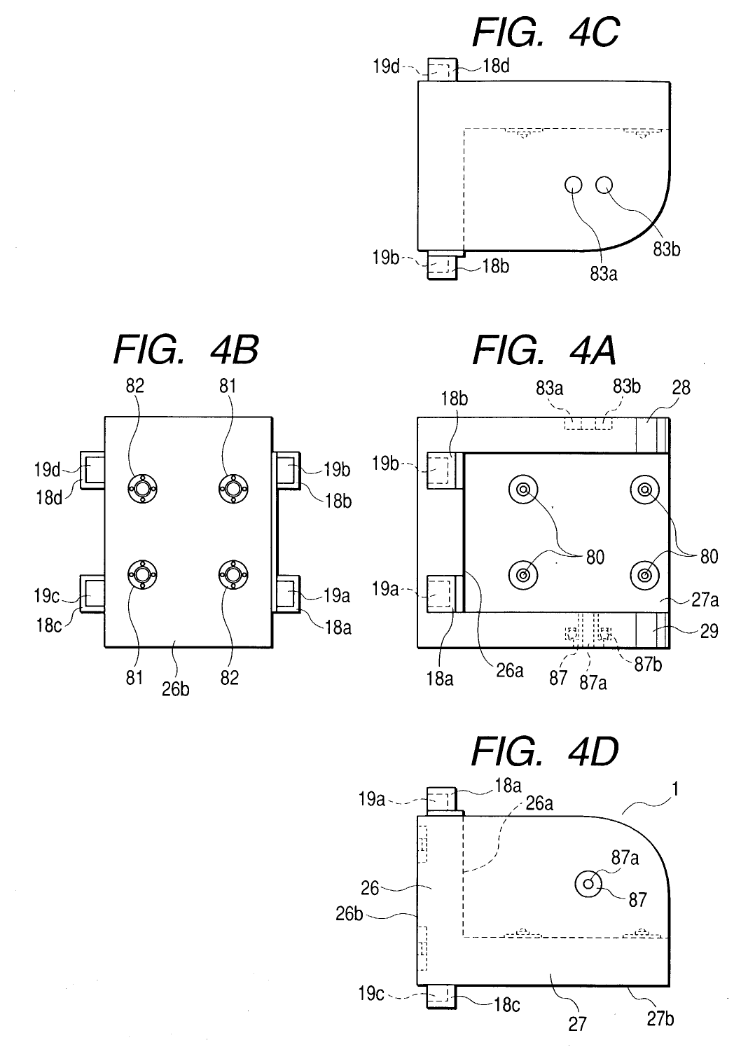

In the present invention, an L-shaped pallet base 1 is used in addition to the pallet 3. The L-shaped pallet base 1 will hereinafter be described with reference to FIGS. 4A, 4B, 4C and 4D. FIGS. 4A, 4B, 4C and 4D show the L-shaped pallet base 1. FIG. 4A shows the front of the L-shaped pallet base 1, FIG. 4B shows the bottom surface of the L-shaped pallet base 1, and FIG. 4C and FIG. 4D show a side of the L-shaped pallet base 1.

The L-shaped pallet base 1 is provided with a first plate-like portion 26 having an upper surface 26a and a lower surface 26b, and a second plate-like portion 27 having an upper surface 27a and a lower surface 27b. The second plate-like portion 27 is coupled to the edge portion of the upper surface 26a of the first plate-like portion 26 so as to form a substantially right angle with respect to the first plate-like portion 26. Strictly, the first lower surface 26b of the first plate-like portion 26 and the second upper surface 27a of the second plate-like portion 27 are substantially perpendicular to each other.

The lower surface of the first plate-like portion 26 constitutes the bottom of the L-shaped pallet base 1 when the L-shaped pallet base 1 is placed on the machining table 51. As on the lower surface 3b of the pallet 3, female side clamps which are second engaging means are disposed on the lower surface 26b of the first plate-like portion 26 which becomes opposed to the surface of the machining table 51 when the L-shaped pallet base 1 is placed on the machining table 51. These female side clamps comprise two kinds i.e., two female side guide clamps 81 and two female side datum clamps 82, thus four in total. Further, similarly to the pallet 3, two handles 18a, 18b and two handles 18c, 18d, thus four in total, are attached to a side of the first plate-like portion 26 to which the second plate-like portion 27 is attached and a side opposite thereto. The handle 18a and the handle 18b are disposed so as to be line-symmetrical with respect to a line passing through the center of the first plate-like portion 26, and the handle 18c and the handle 18d are also disposed so as to be line-symmetrical with respect to a line passing through the center of the first plate-like portion 26. The handle 18a, the handle 18b, the handle 18c and the handle 18d have an aperture 19a, an aperture 19b, an aperture 19c and an aperture 19d, respectively, formed in the sides thereof adjacent to the lower surface 26b of the first plate-like portion 26.

Four male side clamps 80 which are first engaging means are attached to the second upper surface 27a of the second plate-like portion 27 which corresponds to the internal angle side of the angle formed by the first plate-like portion 26 and the second plate-like portion 27. The four male side clamps 80 are arranged in the same pattern so as to correspond to the respective locations of the female side guide clamps 81 and female side datum clamps 82 disposed on the lower surface 3b of the pallet 3. Accordingly, the four male side clamps 80 can be receive in respective ones of the female side guide clamps 81 and female side datum clamps 82 to thereby fix the pallet 3 onto the second surface of the second plate-like portion.

A side plate 28 and a side plate 29 perpendicular to both of the first plate-like portion 26 and the second plate-like portion 27 are attached to the sides of the first plate-like portion 26 and the second plate-like portion 27. Both of the side plate 28 and the side plate 29 have surfaces substantially perpendicular to both of the first plate-like portion 26 and the second plate-like portion 27, and serve to reinforce the first plate-like portion 26 and the second plate-like portion 27.

A socket 83 is attached to substantially the center of the side plate 28. The socket 83 is a concave portion including two counter-sunk apertures 83a and 83b capable of receiving thereinto pins 38a and 38b, respectively, disposed on a turning apparatus which will be described later.

There is disposed a rotating portion 87 having as the center axis a portion substantially corresponding to substantially the center of the side plate 29 and to the middle point of a straight line linking the center of the aperture 83a and the center of the aperture 83b together. The rotating portion 87 is a hollow cylindrical member and is contained in the side plate 29. The hollow portion 87a of the rotating portion 87 receives thereinto a projected portion 39 disposed on the turning apparatus which will be described later. The rotating portion 87 is fitted so as to contact with the inner race of a bearing 87b disposed in the side plate 29 and around the rotating portion 87, while on the other hand, the outer race of the bearing 87b is in contact with the side plate 29. By this bearing, the rotating portion 87 is rotatable relative to the L-shaped pallet base 1.

The L-shaped pallet base 1 holds the pallet 3 in its vertically stood state, and in that state, the L-shaped pallet base 1 itself becomes fixable to the machining table and therefore, achieves an excellent effect in that it can machine the upper surface of the workpiece.

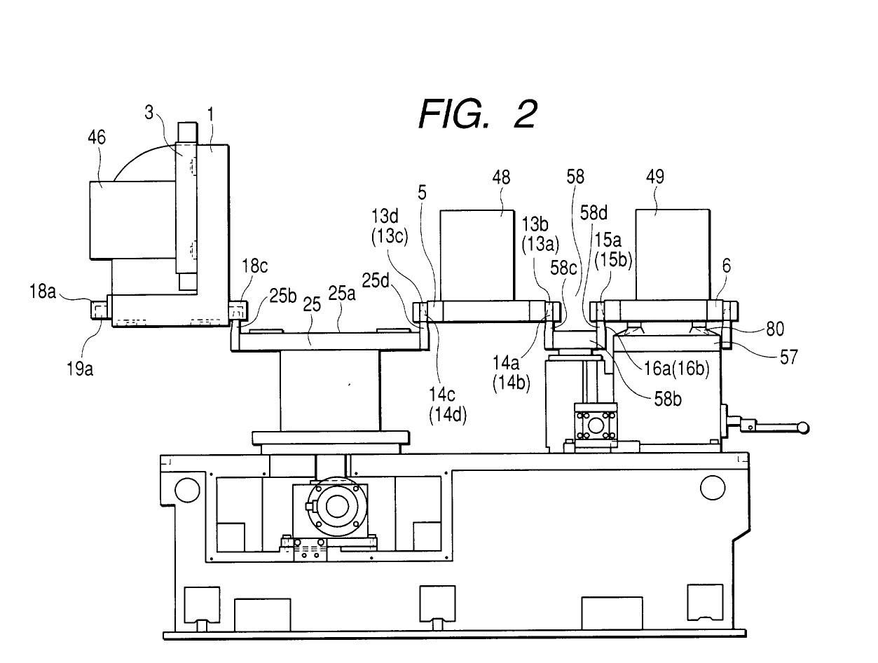

The disc table 25, the workpiece exchange stand 57, the first pallet delivery device 58 and the second pallet delivery device 59 will now be described with reference to FIGS. 1 and 2. The disc table 25, as in the conventional apparatus, is rotatable about the central shaft 25a thereof which is in a vertical direction. In the present invention, however, male side clamps 80 are not disposed on the upper surface of the disc table 25. Instead, an arm 25b, an arm 25c, an arm 25d and an arm 25e, each two of which form a pair, are disposed on substantially the outer peripheral portion of the disc table 25 so as to extend vertically upwardly from the disc table 25. The arm 25b, the arm 25c, the arm 25d and the arm 25e are mounted so as to substantially equally divide the disc table 25 into four. The respective two arms constituting the arm 25b, the arm 25c, the arm 25d and the arm 25e are substantially equal in width to the apertures 12a and 12b and the apertures 12c and 12d of the pallet 3, or respective apertures 19a, 19b, 19c and 19d provided in the handles 18a and 18b, and the handles 18c and 18d of the L-shaped pallet base 1, and can be fitted into these apertures.

The workpiece exchange stand 57 is the same as the aforedescribed conventional workpiece exchange stand 57. The workpiece exchange stand 57 is provided with four male side clamps 80 on the upper surface thereof to place the pallet 6 thereon. The interval between adjacent ones of the male side clamps 80 is D and the male side claims 80 are adapted to fit into the female side guide clamps 81 and the female side datum clamps 82 disposed on the lower surface of the pallet 6 to thereby fix the pallet 6. The first pallet delivery device 58 is disposed between the workpiece exchange stand 57 and the disc table 56.

The first pallet delivery device 58 also is the same as the aforedescribed conventional first pallet delivery device. The first pallet delivery device 58 is provided with a rotary stand 58b rotated about the vertically extending central shaft 58a thereof and an arm 58c and an arm 58d protruding vertically upwardly from the upper surface of the rotary stand 58b. Each of the arm 58c and the arm 58d comprises a pair of arms, and they are disposed rotation-symmetrically with respect to the central shaft 58a and disposed line-symmetrically with respect to a line linking the central shaft 58a and the central shaft 25a of the disc table 25 together. The arm 58c is inserted in the apertures 14a and 14b (apertures corresponding to the apertures 12a and 12b in FIG. 3) of the handles 13a and 13b of the pallet 5 (handles corresponding to the handles 11a and 11b of the pallet 3 in FIG. 3). The pallet 5 is supported thereby. On the other hand, the arm 58d is inserted in the apertures 16a and 16b (apertures corresponding to the apertures 12a and 12b in FIG. 3) of the handles 15a and 15b of the pallet 6 (handles corresponding to the handles 11a and 11b of the pallet 3 in FIG. 3). The pallet 6 is supported thereby. Further, although not shown in FIG. 3, the arm 58c or the arm 58d is fitted in the apertures 19a to 19d (FIGS. 4A to 4D) of the handles 18a to 18d, respectively, of the L-shaped pallet base 1, whereby the L-shaped pallet base 1 can also be supported.

Assuming now that the point of intersection between the diagonal lines of the four male side clamps 80 disposed on the workpiece exchange stand 57 is the center of the workpiece exchange stand 57, a line linking the central shaft 25a of the disc table 25, the central shaft 58a and the center of the workpiece exchange stand 57 together is disposed so as to lie on a straight line. The two arms of the arm 58c and the two arms of the arm 58d, of the first pallet delivery device 58 are disposed so as to be line-symmetrical with respect to this straight line. Also, the locations of the first pallet delivery device 58 and the disc table 25, as shown in FIG. 1 or FIG. 2, are set to such locations that in a position in which the arm 58c of the first pallet delivery device 58 fits into the apertures 14a and 14b of the handles 13a and 13b, respectively, of the pallet 5, the arm 25d of the disc table 25 also can fit into the apertures 14c and 14d of the handles 13c and 13d, respectively, on the opposite side of the pallet 5.

The machining table 51, like the workpiece exchange stand 57, is provided with four male side clamps 80 on the upper surface thereof to place a pallet 8 (the same as the pallet 3) thereon. The interval between adjacent ones of the male side clamps 80 is D and they are adapted to fit into the female side guide clamps 81 and the female side datum clamps 82 disposed on the lower surface of the pallet 8 to thereby fix the pallet 8. The second pallet delivery device 59 is disposed between the machining table 51 and the disc table 25.

The second pallet delivery device 59 will now be descried. The second pallet delivery device 59 is substantially of the same structure as the first pallet delivery device 58. The second pallet delivery device 59 is provided with a rotary stand 59b rotated about the vertical central shaft 59a thereof, and an arm 59c and an arm 59d protruding vertically upwardly from the upper surface of the rotary stand 59b. The arm 59c is inserted in the apertures 7c and 7d (apertures corresponding to the apertures 12a and 12b in FIG. 3) of handles 7a and 7b (handles corresponding to the handles 11a and 11b of the pallet 3 in FIG. 3), respectively. The pallet 7 is supported thereby. The arm 59d is inserted in the apertures 8c and 8d (apertures corresponding to the apertures 12a and 12b in FIG. 3) of handles 8a and 8b (handles corresponding to the handles 11a and 11b of the pallet 3 in FIG. 3), respectively. The pallet 8 is supported thereby.

Assuming now that the point of intersection between the diagonal lines of the four male side clamps 80 disposed on the machining table 51 is the center of the machining table 51, a line linking the central shaft 25a of the disc table 25, the central shaft 59a and the center of the machining table 51 at the origin position together is disposed so as to lie on a straight line. The two arms of the arm 59c and the two arms of the arm 59d, of the second pallet delivery device 59 are disposed so as to be line-symmetrical with respect to this line. Also, the locations of the second pallet delivery device 59 and the disc table 25, as shown in FIG. 1, are set so that when the arm 59c of the second pallet delivery device 59 fits into the respective apertures 7c and 7d of the handles 7a and 7b of the pallet 7 to thereby hold the pallet 7, the arm 25e of the disc table can fit into the respective apertures (apertures corresponding to the apertures 12a and 12b in FIG. 3 and the details thereof being not shown) of the handles 7e and 7f on the opposite side of the pallet 7 (handles corresponding to the handles 11a and 11b of the pallet 3 in FIG. 3).

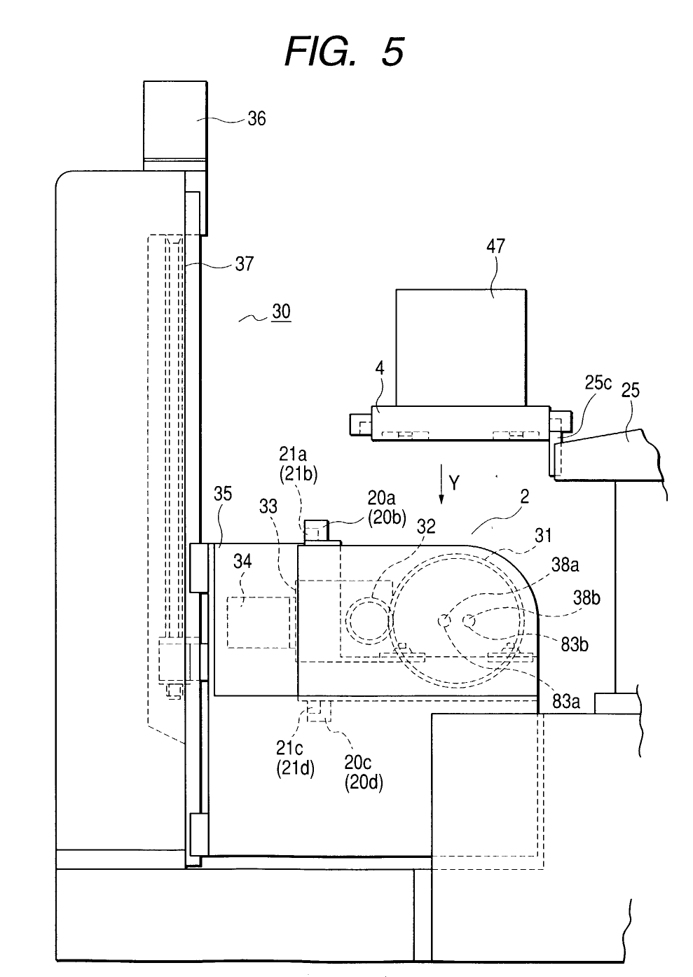

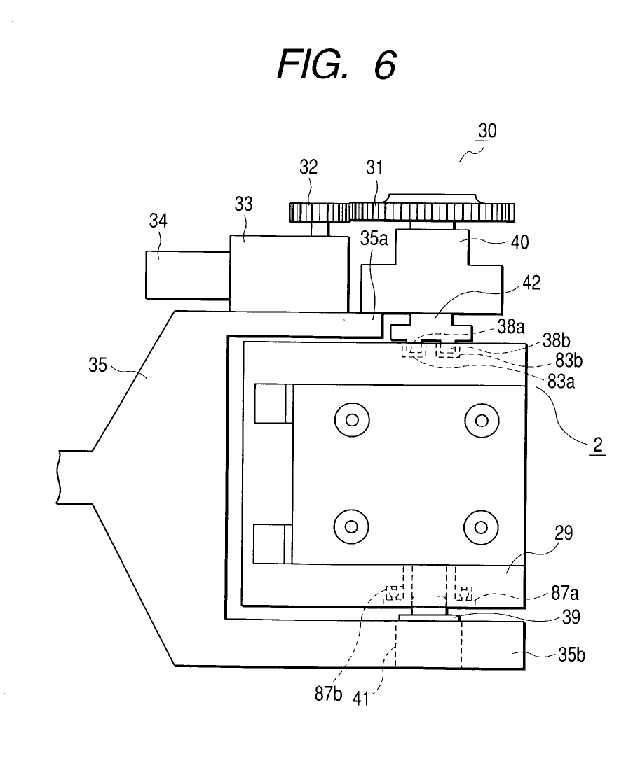

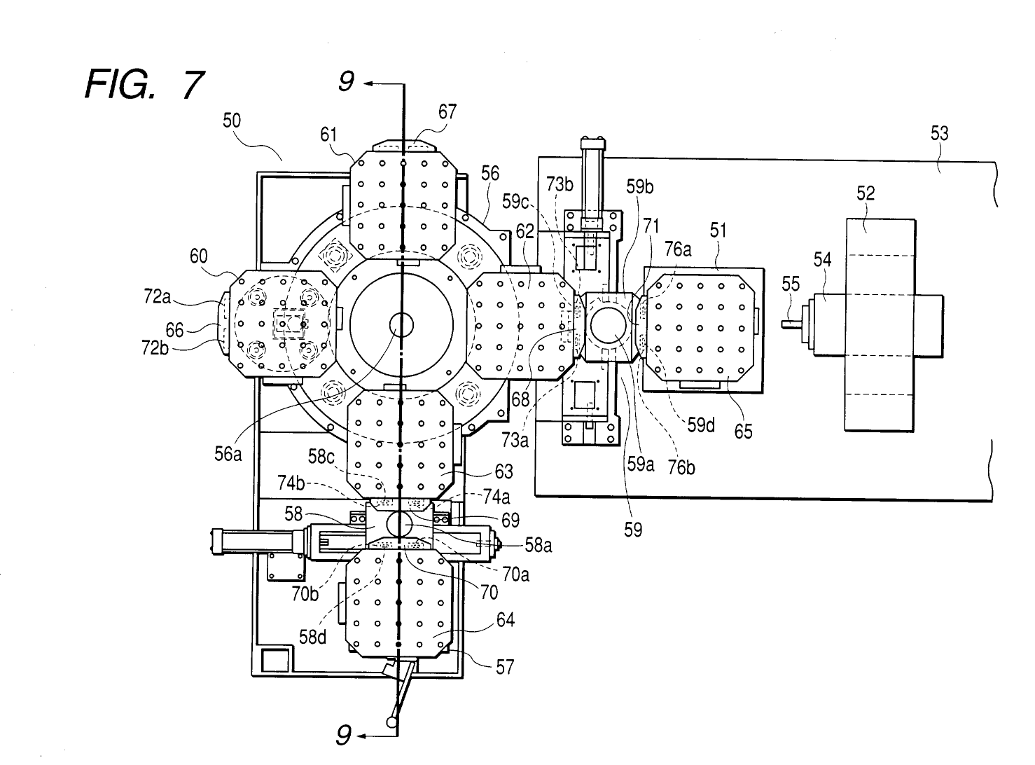

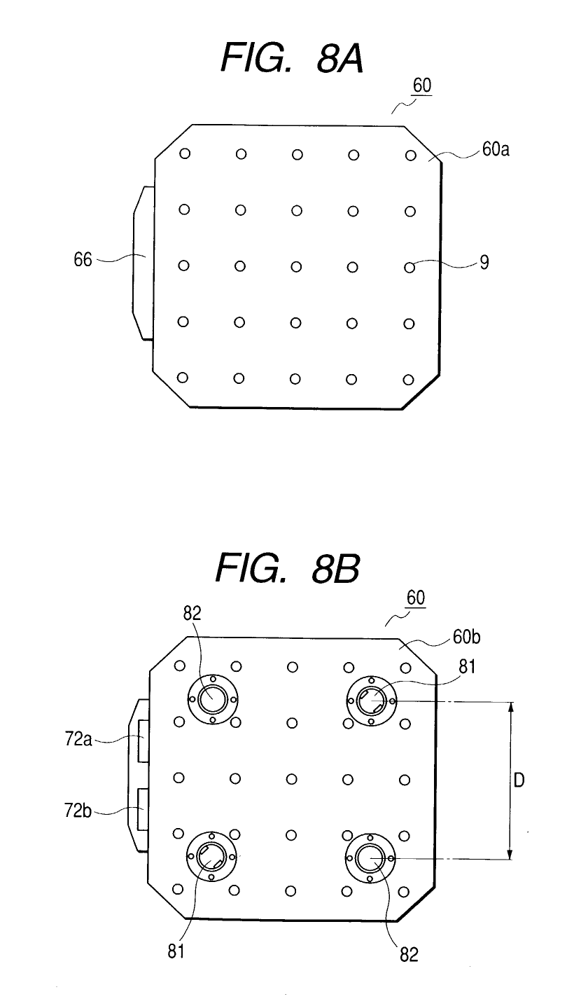

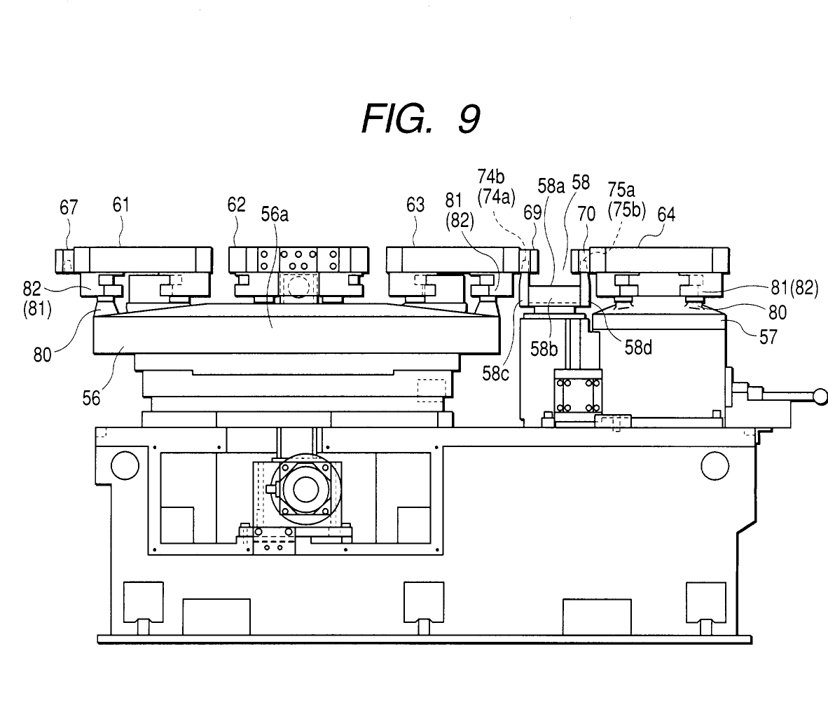

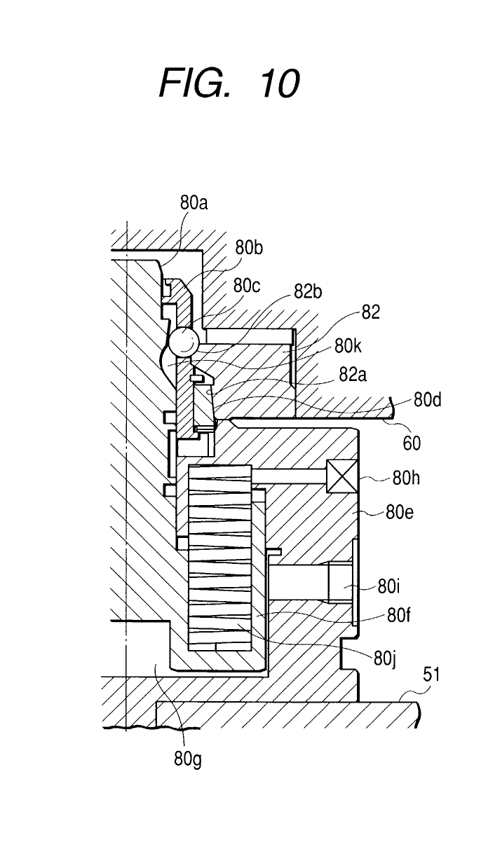

The turning apparatus 30 will now be described with reference to FIGS. 5 and 6. FIG. 5 is a side view of the turning apparatus 30, and FIG. 6 is a view taken along the arrow Y of FIG. 5. The turning apparatus 30 is an apparatus for shifting the L-shaped pallet base 2, when used in the present invention, from a horizontally held state in which the second plate-like portion 27 of the L-shaped pallet base 2 is lowered to a vertically held state in which the first plate-like portion 26 is lowered, or for effecting the converse thereof. That is, when the pallet 4 to which the workpiece is fixed is to be mounted on the L-shaped pallet base 2, the work is executed in the horizontally held state (the state of FIG. 5) in which the second plate-like portion 27 is lowered, but to fit to the arm 25c of the disc table 25 to convey the L-shaped pallet base 2, it is necessary to turn and elevate the L-shaped pallet base 2 until the vertically held state in which the first plate-like portion 26 is lowered is brought about. The turning apparatus 30 is disposed in proximity to the disc table of the pallet exchanging apparatus 10 for the purpose of that work.

The turning apparatus 30 is provided with a main body portion 35, reduction gears 33 and a servomotor 34. The main body portion 35 is provided with a main body portion side plate 35a disposed so as to be opposed to the side plate 28 of the L-shaped pallet base 2, and a main body portion side plate 35b disposed so as to be opposed to the side plate 29 of the L-shaped pallet base 2, and an L-shaped pallet base 2 which is an object to be turned is disposed so as to be enclosed between the main body portion side plate 35a and the main body portion side plate 35b. The reduction gears 33, the servomotor 34 and a first cylinder 40 are provided on the main body portion side plate 35a side, and a second cylinder 41 is mounted on the main body portion side plate 35b side. A gear 32 is mounted on the reduction gears 33 and is rotatable by the servomotor 34. The first cylinder 40 which is a hydraulic cylinder is provided on the distal end side of the main body portion side plate 35a. A rod 42 is disposed in the first cylinder 40 so as to be slidable perpendicularly to the main body portion side plate 35a. A pin 38a and a pin 38b are disposed on the fore end of the rod 42 so as to protrude perpendicularly to the main body portion side plate 35a from the rod 42, and a gear 31 is mounted on the rear end of the rod 42 perpendicularly to the rod 42. Usually the gear 31 is not in engagement with the gear 32. When the first cylinder 40 is actuated, the rod 42 protrudes from the first cylinder 40, and the pin 38a and the pin 38b are received into the socket 83a and the socket 83b, respectively, of the L-shaped pallet base 2. In this state, the gear 31 comes into engagement with the gear 32, and the gear 31 is rotated by the rotation of the servomotor 34 through the gear 32.

On the other hand, the second cylinder 41 which is a hydraulic cylinder is disposed on the main body portion side plate 35b side so as to be contained in the main body portion side plate 35b. A projected portion 39 is disposed in the second cylinder 41, and when the second cylinder 41 is actuated, the projected portion 39 operates so as to protrude perpendicularly from the main body portion side plate 35b. The projected portion 39 which has protruded is received into the hole 87a of a rotating portion 87. Accordingly, when the first cylinder and the second cylinder are actuated, the pin 38a and the pin 38b are received into the socket 83a and the socket 83b, respectively, and the projected portion 39 is received into the rotating portion 87, and the L-shaped pallet base 2 becomes held by the main body portion 35.

When in this state, the servomotor 34 is rotated, the gear 31 is rotated through the gear 32. The rotation of the gear 31 is transmitted to the pin 38a and the pin 38b, and the L-shaped pallet base 2 rotatively shifts from the horizontally held state in which the second plate-like portion 27 of the L-shaped pallet base 2 is lowered to the vertically held state in which the first plate-like portion 26 is lowered, with the intermediate point of the socket 83a and the socket 83b of the L-shaped pallet base 2 as the center axis. At this time, since the projected portion 39 is received into the hole 87a of the rotating portion 87 and therefore, the rotating portion 87 can be smoothly rotated by a bearing provided in the side plate 29.

Further, the main body portion 35 of the turning apparatus 30 is threadably fitted to a long bar 37 provided with a threaded portion. Also, a motor 36 is mounted on one end of the long bar 37, and when the motor 36 is rotated, the long bar 37 is rotated and the main body portion 35 can be moved up and down along the thread of the threaded portion.

The turning apparatus is in such a positional relation in which even if it is moved up and down while being in the horizontally held state in which the second plate-like portion 27 of the L-shaped pallet base 2 is lowered, it will not collide with the disc table 25, while on the other hand, it is characterized in that in the vertically held state in which the first plate-like portion 26 of the L-shaped pallet base 2 is lowered, the each of the apertures 21c and 21d of the handles 20c and 20d of the L-shaped pallet base 2 are located right above the arm 25c of the disc table 25.

On the basis of the above-described construction of the apparatus of the present invention, how the apparatus of the present invention is used will now be described with reference to FIGS. 1 to 5. First, the workpiece to be machined is fixed to the pallet 6 on the workpiece exchange stand 57. Subsequently, oil pressure is applied to the male side clamps 80 to thereby liberate the male side clamps 80 from the female side guide clamps 81 and the female side datum clamps 82. When substantially simultaneously therewith, the rotary stand 58b of the first pallet delivery device 58 is elevated, the arm 58c and the arm 58d of the first pallet delivery device 58 are elevated and fit into the apertures of the handles of the pallet 5 and the pallet 6. When the rotary stand 58b is further elevated after the arm 58c and the arm 58c have completely fitted into the apertures, the arm 58d and the arm 58d raise the pallet 5 and the pallet 6, respectively. When in this state, the rotary stand 58b is rotated, the pallet 5 and the pallet 6 are rotated and change places with each other. When here, the rotary stand 58b is lowered to its original constant position, the pallet 6 fits to the arm 25d of the disc table 25 and is held thereby, while the pallet 5 is fitted to the male side clamps 80 on the workpiece exchange stand 57. The oil pressure to the male side clamps 80 is released here. The disc table 25 is then rotated to thereby convey the pallet 6 to the second pallet delivery device 59. Here, the second pallet delivery device 59 is likewise operated to thereby place the pallet 6 on the machining table 51.

As already described, the upper surface of the workpiece cannot be worked by the pallet 6. Accordingly, description will now be made of a case where the upper surface of the workpiece is worked. The pallet 4 to which the workpiece has already been fixed is mounted on the L-shaped pallet base. The mounting is effected as follows.

First, the pallet 4 is held by the arm 25c of the disc table 25 and is disposed at the location of the turning apparatus 30. On the other hand, the first cylinder 40 and second cylinder 41 of the turning apparatus 30 are actuated to thereby cause the pin 38a and the pin 38b to fit into the socket 83a and the socket 83b, respectively, and cause the projected portion 39 to fit into the hole 87a, thereby holding the L-shaped pallet base 2 in a horizontal state in which the second plate-like portion 27 thereof is lowered (the state of FIG. 5). Here, oil pressure is applied to the male side clamps 80 of the L-shaped pallet base 2 to thereby liberate the male side clamps 80. Here, the motor 36 is rotated to thereby elevate the main body portion 35 of the turning apparatus 30. The main body portion 35 of the turning apparatus 30 is elevated until the male side clamps 80 of the L-shaped pallet base 2 fit into the female side guide clamps 81 and female side datum clamps 82 of the pallet 4 held by the arm 25c of the disc table 25. When the oil pressure to the male side clamps 80 is released after the male side clamps 80 of the L-shaped pallet base 2 have fitted into the female side guide clamps 81 and female side datum clamps 82 of the pallet 4, the pallet 4 is fixed to the L-shaped pallet base. In the state of this posture, the motor 36 is further rotated to thereby elevated the L-shaped pallet base 2, and at a predetermined stage whereat the L-shaped pallet base 2 has become located above the disc table 25, the motor 34 of the turning apparatus is actuated to thereby rotate the gear 32 and the gear 31 and turn the L-shaped pallet base 2. Thereupon, the L-shaped pallet base 2 becomes upright in its vertical state with the aperture 21c of the handle 20c and the aperture 21d of the handle 20d, of the L-shaped pallet base 2 located right above the arm 25c. When here, the motor 36 is reversely driven to thereby lower the main body portion 35, the L-shaped pallet base 2 is lowered and the arm 25c fits into the respective apertures 21c and 21d of the handles 20c and 20d of the L-shaped pallet base 2, and the L-shaped pallet base 2 is held on the disc table 25. When the first cylinder 40 and the second cylinder 41 are actuated at a stage whereat the L-shaped pallet base 2 has been held by the arm 25c, the rod 42 is contained into the first cylinder 40 and the pin 38a and the pin 38b come out of the sockets 83a and 83b, respectively, and the projected portion 39 comes out of the rotating portion 87 and is contained into the second cylinder 41, and the L-shaped pallet base 2 is separated from the turning apparatus 30 and is held only by the arm 25c of the disc table 25. Here, the motor 36 of the turning apparatus 30 is rotated to hereby lower and retract the main body portion 35 along the long bar 37. The L-shaped pallet base 2 held by the disc table 25 is conveyed to the machining table 51 by the disc table 25 being rotated in the same manner as the conveyance of the pallet 3.

Also, in the present invention, design is made such that the L-shaped pallet base 1 and the pallet 3 are held on the disk table 25 only by the handles. This is advantageous in that a large space can be secured under the pallet. This space is advantageous in that it can be utilized as a rotation space for the L-shaped pallet base 1 by the turning apparatus.

Also, in the present invention, the L-shaped pallet base 1 and the pallet 3 are held on the disc table 25 only by the handles, whereby it is not necessary to provide male side clamps 80 on the disc table 25, and it never happens that the cut powder of machining falls onto the male side clamps 80 and therefore the female side guide clamps 81 and the female side datum clamps 82 absorb this cut powder to thereby cause a hindrance to the fitting between the two. In the present invention, the first engaging means are the male side clamps 80 and the second engaging means are the female side guide clamps 81 and the female side datum clamps 82, but as far as there is created the effect that two parts are engaged with each other and fixed, it is not intended that these parts be restrictive.

The following advantageous effects are achieved by the present invention.

(1) By the L-shaped pallet base being utilized, the L-shaped pallet base 1 holds the pallet in its vertically stood state, and in that state, the L-shaped pallet base itself becomes fixable to the machining table. Accordingly, an excellent effect is achieved in that the upper surface of the workpiece can be machined.

(2) Design is made such that the pallet is held on the disc table only by the handles. This is advantageous in that a large space can be secured under the pallet. For example, the turning apparatus can be placed in this space.

(3) There is the feature that with the L-shaped pallet base brought into its horizontal state, the pallet can be fixed to the L-shaped pallet base by only the upward and downward movement of the turning apparatus and further, after the vertically held state in which the first plate-like portion of the L-shaped pallet base is lowered has been brought about by the turning apparatus, the L-shaped pallet base can be disposed by only the upward and downward movement of the turning apparatus so that the apertures of the handles of the L-shaped pallet base may be positioned right above the arms of the disc table.

(4) The L-shaped pallet base 1 and the pallet 3 are held on the disc table 25 only by the handles, whereby it is not necessary to provide male side clamps 80 on the disc table 25, and it never happens that cut powder of machining falls onto the male side clamps 80 and therefore the female side guide clamps 81 and the female side datum clamps 82 absorb this cut powder to thereby cause a hindrance to the fitting between the two, and this is advantageous for the maintenance and custody of the apparatus. While the described embodiment represents the preferred form the present invention, it is to be understood that modifications will occur to those skilled in that art without departing from the spirit of the invention. The scope of the invention is therefore to be determined solely by the appended claims.

What is claimed is:

1. An L-shaped pallet base for use in a pallet exchanging apparatus in a machining center with a machining table having first engaging means on a top surface of the machining table, and for supporting a pallet including a surface having second engaging means engageable with the first engaging means and another surface for mounting a workpiece thereon, comprising:
a first plate including a first upper surface and a first lower surface having second engaging means; and
a second plate including a second upper surface including first engaging means and positioned substantially perpendicularly to the first plate;
wherein the second upper surface is positioned on an internal angle side so as to face the first upper surface, and the pallet can be fixed by the second engaging means being engaged with the first engaging means on the second upper surface.

2. An L-shaped pallet base according to claim 1, further comprising a handle at a peripheral side of the first plate, the handle including an opening in a side of the first lower surface.

3. An L-shaped pallet base according to claim 1 or 2, wherein the arrangement patterns of the first engaging means of the machining table, the first engaging means of the second upper surface, the second engaging means of the first lower surface and the second engaging means of the pallet are common.

4. An L-shaped pallet base according to claim 3, wherein the first engaging means comprises a projection including a concavity in the peripheral surface thereof and a moving member movable in the radial direction of the projection by sliding the surface of the concavity, and
the second engaging means has a hole for receiving the projection therein and a stopper for stopping the moving member.

5. A pallet for use with an L-shaped pallet base used in a pallet exchanging apparatus in a machining center with a machining table having first engaging means on a top surface of the machining table, comprising:
a surface having second engaging means engageable with the first engaging means;
another surface for mounting a workpiece thereon;
a side surface; and
another side surface parallel to the side surface;
wherein each of the side surface and said another side surface has a handle including an opening in a side of said surface having the second engaging means,
the L-shaped pallet base comprises:
a first plate including a first upper surface and a first lower surface having second engaging means; and
a second plate including a second upper surface including first engaging means and positioned substantially perpendicularly to the first plate;
the second upper surface is positioned on an internal angle side so as to face the first upper surface, and
the pallet can be fixed by the second engaging means being engaged with the first engaging means on the second upper surface.

6. A pallet exchanging apparatus for use in a machining center with a machining table having first engaging means on a top surface of the machining table and for exchanging a location of a pallet and an L-shaped pallet base, comprising:
a circular plate rotatable about a vertical axis; and
a hook disposed at the peripheral area of the circular plate and projecting along the direction of the vertical axis from the circular plate;
wherein the pallet comprises:
a surface having second engaging means engageable with the first engaging means;
another surface for mounting a workpiece thereon;
a side surface; and
another side surface parallel to the side surface;
each of the side surface and said another side surface has a handle including an opening in a side of said surface having the second engaging means,
the L-shaped pallet base comprises:
a first plate including a first upper surface and a first lower surface having second engaging means; and
a second plate including a second upper surface including first engaging means and positioned substantially perpendicularly to the first plate;
the second surface is positioned on an internal angle side so as to face the first upper surface,
the pallet can be fixed by the second engaging means being engaged with the first engaging means on the second upper surface, and
the hook supports the pallet or the L-shaped pallet base by being inserted into said opening in each handle.
